(19) United States
(12) Patent Application Publication
(10) Pub. No.: US 2010/0026908 A1
(43) Pub. Date: Feb. 4, 2010

(54) PROJECTOR CAPABLE OF DISPLAYING INFORMATION VIA PROJECTION SCREEN OR EXTERNAL DISPLAY AND DISPLAYING METHOD THEREOF

(75) Inventor: MING-CHANG LIN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/334,532

(22) Filed: Dec. 15, 2008

(30) Foreign Application Priority Data
Aug. 1, 2008 (CN) 200810303305.4

(51) Int. Cl. H04N 9/31

(52) U.S. Cl. 348/744; 348/E09.025

(57) ABSTRACT

A displaying method of a projector is disclosed. The projector includes an A/V processor, an output connector, and a detector. The A/V processor is configured for reading A/V data from a data source and processing the A/V data to output corresponding A/V signals. The output connector is configured for outputting the A/V signals to an external display. The output connector includes a pin which outputs synchronization frames of the A/V signals when the output connector is not connected to the external display. The displaying method includes: powering on and initializing the projector; and detecting synchronization frames of the output A/V signals from the pin, if yes, powering on the light source, if no, powering off the light source.

### BACKGROUND

1. Technical Field

The present disclosure relates to projectors and, particularly, to a projector which can display information via a projection screen or an external display, and a displaying method thereof.

2. Description of the Related Art

It is not uncommon that sometimes users wish to use a projector for conference presentations and choose to use a display instead for small-group discussions. Accordingly, with limited instruments, the users may need to interchange connections between a data source and the projector or the display, which is inconvenient and inefficient.

Therefore, it is desirable to provide a projector and a displaying method thereof, which can overcome the above-mentioned problem.

### BRIEF DESCRIPTION OF THE DRAWINGS

FIG. 1 is a functional block diagram of a projector, according to an exemplary embodiment.

FIG. 2 is a functional block diagram of a projector, according to another exemplary embodiment.

FIG. 3 is a flowchart of a displaying method of a projector, according to another embodiment.

### DETAILED DESCRIPTION OF THE EMBODIMENTS

Embodiments of the present projector and displaying method thereof will now be described in detail with references to the accompanying drawings.

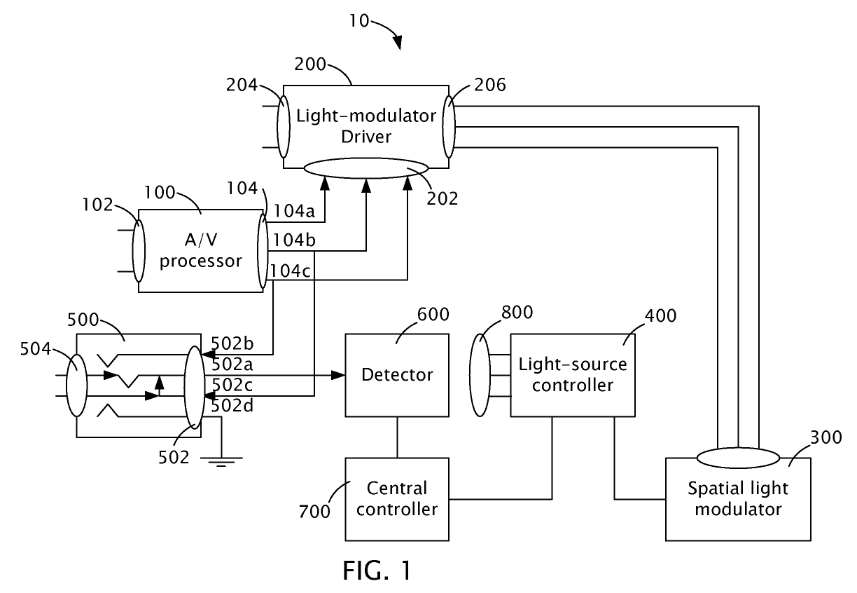

Referring to FIG. 1, a projector 10, according to an exemplary embodiment, includes an audio/video (A/V) processor 100, a light-modulator driver 200, a spatial light modulator (SLM) 300, a light-source controller 400, an output connector 500, a detector 600, a central controller 700, and a light source 800. The A/V processor 100 is configured for reading A/V data from an external device (not shown), and processing the read A/V data to output corresponding A/V signals. The output connector 500 is connected to the A/V processor 100 for receiving and transmitting the A/V signals to an external display (not shown). The detector 600 is connected to the output connector 500, and is configured for detecting whether the output connector 500 is connected to the external display. If the output connector 500 is connected to the external display, the central controller 700 is informed by the detector 600 to instruct the light-source controller 400 not to power on the light source 800.

The A/V processor 100 includes an input port 102. The input port 102 is used to connect the A/V processor 100 to a data source. The data source can be, for example, a computer or a television (TV).

The A/V processor 100 may include various decoders, such as a moving pictures experts group (MPEG)-1 decoder, an MPEG-2 decoder, an MPEG-4 decoder, a real-video decoder, a motion joint photographic experts group (M-JPEG) decoder, and an audio decoder. Thereby, the A/V processor 100 can decode video stream and sound contained in the read A/V data, and outputting the corresponding A/V signals.

The A/V processor 100 can also include a de-multiplexer interface that can interface with a digital video broadcasting-terrestrial (DVB-T) or digital multimedia broadcast-terrestrial (DMB-T) demodulator to receive TV contents.

The A/V processor 100 further includes an output port 104 consisting of three channels 104a, 104b, 104c for outputting the A/V signals. In this embodiment, if the input port 102 is connected to a computer, the channel 104a/c is for outputting a red/blue (R/B) component of the A/V signals, and the channel 104b is for outputting a green (G) component of the A/V signals. Accordingly, the output port 104 can be a composite video connector, a separated video (S-Video) connector, or a component video connector. If the input port 102 is connected to a TV, the channel 104b is for carrying a luminance component, and the channel 104a/c is for carrying a red-luma/blue-luma difference component. In this case, the output port 104 can be a digital visual interface (DVI) connector, or a high-definition multimedia interface (HDMI) connector.

The light-modulator driver 200 includes an internal input 202 and an external input 204. The internal input 202 includes three channels respectively connecting to the three channels 104a, 104b, 104c. The external input 204 is used for receiving A/V signals directly from a data source. The light-modulator driver 200 is configured for converting the A/V signals into driving signals. The light-modulator driver 200 also includes an output 206 for outputting the driving signals.

The SLM 300 such as a liquid crystal display (LCD) panel, a liquid crystal on silicon (LCoS) panel, a digital micro-mirror device (DMD), includes an input connected to the output 206 and is configured for modulating light emitted from the light source 800 according to the input driving signals to produce optical images which will be projected onto a screen (not shown).

The light-source controller 400 is for driving the light source 800 to light. The light source 800 can be a light emitting diode (LED) light source or a high-power lamp. In this embodiment, the light source 800 includes three groups of color LEDs, such as red, green, and blue groups of LEDs. The SLM 300 is capable of generating three sequence-waveform driving signals based upon the input driving signals. Each sequence-waveform driving signal is configured for controlling a corresponding group of colored LEDs to turn on and off.

The output connector 500 may be a (S-video) connector, a composite video connector, or a component video connector. The output connector 500 includes an input terminal 502. The input terminal 502 includes two pins 502b, 502c respectively connecting to the channels 104b, 104c for receiving A/V signals from the A/V processor 100. The output connector 500 also includes an output terminal 504 for outputting the A/V signals to the external display, if connected. In addition to the pins 502b, 502c, the input terminal 502 also includes a detectable pin 502a, and a ground pin 502d. The detectable pin 502a is connected to the channel 502b when the output terminal 504 is not connected to the external display but disconnect from the channel 502b when the output terminal 504 is connected to the external display. The ground channel 502d is grounded.

The detector 600 can be a frame synchronization detector and is connected to the detectable pin 502a, and can detect synchronization frames of the A/V signals from the channel 104b, via the pin 502b and detectable pin 502a when the output terminal 504 is not connected to the external display, but not when the output terminal 504 is connected to the external display. If no synchronization frame is detected, the detector 600 will inform the central controller 700 to instruct the light-source controller 400 not to power on the light source 800.

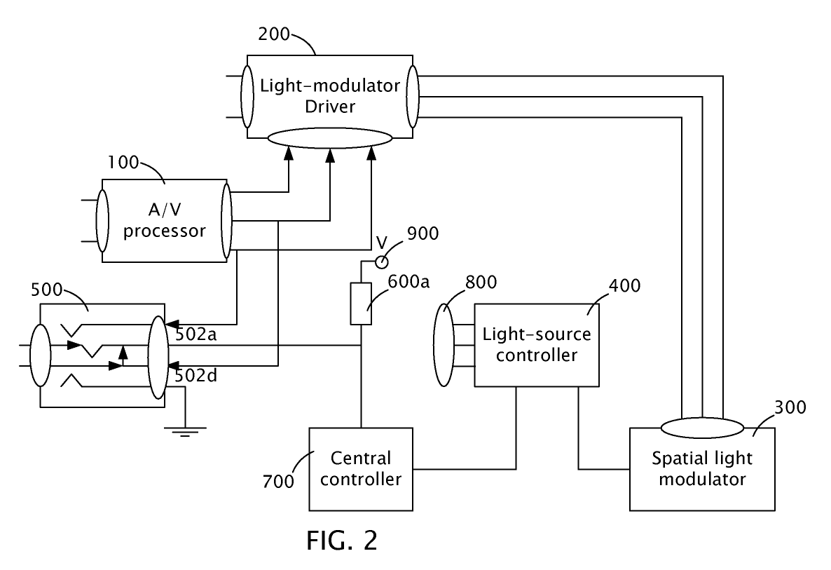

Referring to FIG. 2, in other alternative embodiments, the detector 600a can be a high pull-up resistor. A first node of the detector 600 is connected to a power source 900 and a second node of the detector 600 is connected to the detectable pin 502a and the central controller 700. When the output terminal 504 is not connected to the external display, electrical current generated by the power source 900 flows to the detectable pin 502a, to the pin 502b, and finally to the ground pin 502d. Therefore, the central controller 700 receives a low level and interprets this low level as “power on light source.” In other cases, if the output terminal 504 is connected to the external display, the circuit from the power source 900 to the ground is cut. As a consequence, the central controller 700 receives a high level and interprets this high level as “do not power on light source.”

The projector 10 can display information on the screen or the external display. Therefore, the data source can be connected to the input port 102 all along. Interchange between the screen and the external display can be automatically accomplished by the detector 60/60a and the central controller 700, therefore is more convenient and efficient, as compared with current techniques.

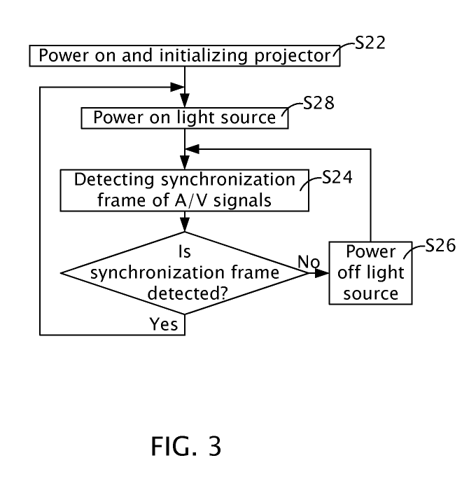

Referring to FIG. 3, a displaying method of the projector 10, according to another exemplary embodiment includes the following steps S22-28.

S22: the projector 10 is powered on and initialized. In this step, the A/V processor 100 can be preset to output the A/V signals in an internal format (projection). That is, the information is displayed on the screen. As a result, the light source 800 is powered on in step S28.

S24: the detector 600 keeps detecting synchronization frames of the A/V signals.

S26: the central controller 700 is informed by the detector 600 to instruct the light-source controller 400 to power off the light source 800 when no synchronization frame is detected any more.

S28: the central controller 700 is informed by the detector 600 to instruct the light-source controller 400 to power on the light source 800 when the synchronization frames are detected again.

It will be understood that the above particular embodiments and methods are shown and described by way of illustration only. The principles and the features of the present invention may be employed in various and numerous embodiments thereof without departing from the scope of the invention as claimed. The above-described embodiments illustrate the scope of the invention but do not restrict the scope of the invention.

What is claimed is:

1. A projector comprising:
an audio/video (A/V) processor configured for reading A/V data from an external device, and processing the read A/V data to output corresponding A/V signals;
a light-modulator driver;
a spatial light modulator;
a light-source controller;
a light source; the light source controller being configured for generated light under control of the light-source controller, the light modulator driver being configured for converting the A/V signals into driving signals, the spatial light modulator being configured for modulating the generated light based upon the driving signals to produce optical images to be projected onto a screen;
an output connector connected to the A/V processor for receiving and transmitting the A/V signals to an external display;
a detector connected to the output connector, and configured for detecting whether the output connector is connected to the external display;
a central controller being configured to be informed by the detector to instruct the light-source controller to power off the light source if the output connector is connected to the external display.

2. The projector as claimed in claim 1, wherein the A/V processor comprises an input port, the input port being configured for connecting the A/V processor to a data source.

3. The projector as claimed in claim 1, wherein the A/V processor comprises a decoder selected from the group consisting of a moving pictures experts group (MPEG)-1 decoder, an MPEG-2 decoder, an MPEG-4 decoder, a real-video decoder, a motion joint photographic experts group decoder, and an audio decoder.

4. The projector as claimed in claim 1, wherein the A/V processor comprises a de-multiplexer interface, the de-multiplexer interface being capable of interfacing with a demodulator selected from the group consisting of a digital video broadcasting-terrestrial and a digital multimedia broadcast-terrestrial demodulator.

5. The projector as claimed in claim 1, wherein the A/V processor comprises an output port, the output port comprises three channels for outputting the A/V signals.

6. The processor as claimed in claim 5, wherein if the A/V processor is connected to a computer, and the three channels are configured for outputting red, green, and blue components of the A/V signals

7. The projector as claimed in claim 5, wherein if the A/V processor is connected to a television, and the three channels are configured for carrying luma, red-luma difference, and blue-luma difference components of the A/V signals.

8. The processor as claimed in claim 5, wherein the output port comprises a connector selected from the ground consisting of a composite video connector, a separated video connector, a component video connector, a digital visual interface connector, and a high-definition multimedia interface connector.

9. The projector as claimed in claim 1, wherein the light-modulator driver comprises an internal input, the internal input is configured for connecting to the A/V processor.

10. The projector as claimed in claim 1, wherein the light modulator comprises an external input, the external input being used for receiving A/V signals directly from a data source.

11. The projector as claimed in claim 1, wherein the spatial light modulator is selected form the group consisting of a liquid crystal display panel, a liquid crystal on silicon panel, and a digital micro-mirror device.

12. The projector as claimed in claim 1, wherein the light source is selected from the group consisting of a light emitting diode (LED) light source and a high-power lamp.

13. The projector as claimed in claimed in claim 1, wherein the light source comprises three groups of color LEDs, the spatial light modulator being capable of generating three sequence-waveform driving signals based upon the input driving signals, each sequence-waveform driving signal being configured for controlling a corresponding group of colored LEDs to turn on and off.

14. The projector as claimed in claim 1, wherein the output connector is selected from the group consisting of a separated video connector, a composite video connector, and a component video connector.

15. The projector as claimed in claim 1, wherein the output connector includes an input terminal, the input terminal comprising two signal pins, a detectable pin and a ground pin, the two signal pins are connected to the A/V processor for receiving A/V signals, the detectable pin is in contact with one of the signal pins when the output connector is not connected to the external display but disconnected from the signal pin when the output connector is connected to the external display, the ground pin is grounded.

16. The projector as claimed in claim 15, wherein the detector is a synchronization frame detector and is connected to the detectable pin, and is configured for detecting synchronization frames of the A/V signals therefrom the channel.

17. The projector as claimed in claim 15, wherein the detector is a high pull-up resistor and comprises a first node and a second node, the projector further comprises a power source, the first node being connected to a power source, the second node being connected to the detectable pin and the central controller, the central controller is capable of instructing the light-source controller to power on the light source when receives a low level from the second node, and instructing the light-source controller to power off the light source when receives a high level from the second node.

18. A displaying method of a projector, the projector comprising an A/V processor, a light source, an output connector, and a detector, the A/V processor being configured for reading A/V data from a data source and processing the A/V data to output corresponding A/V signals, the light source being configured for generated light which is modulated into optical images to be projected onto a screen based upon the A/V signals, the output connector being configured for outputting the A/V signals to an external display, the output connector comprising a pin which outputs synchronization frames of the A/V signals when the output connector is not connected to the external display, the method comprising:
detecting synchronization frames of the output A/V signals from the pin;
powering off the light source if no synchronization frame of the A/V signals is detected; and
powering on the light source if synchronization frames of the A/V signals are detected.

19. The method of claim 18, further comprising the step of keeping powering on the light source if synchronization frames of the A/V signals are detected.
